(19) United States
(12) Patent Application Publication
(10) Pub. No.: US 2016/0232496 A1
(43) Pub. Date: Aug. 11, 2016

(54) CELEBRITY INTERACTION SYSTEM

(71) Applicant: Lorie Lee Underdahl Ingram, Wayzata, MN (US)

(72) Inventor: Lorie Lee Underdahl Ingram, Wayzata, MN (US)

(21) Appl. No.: 14/939,694

(22) Filed: Nov. 12, 2015

Related U.S. Application Data
(60) Provisional application No. 62/080,237, filed on Nov. 14, 2014.

(51) Int. Cl. G06Q 10/10; H04L 29/06; H04L 12/58

(52) U.S. Cl. CPC G06Q 10/1095; H04L 51/046; H04L 65/1069

(57) ABSTRACT

A celebrity interaction system facilitates personal face to face communication between a fan and a celebrity across a network.

### CROSS REFERENCE TO RELATED APPLICATIONS

This application claims priority to U.S. Patent Application Ser. No. 62/080,237 issued on Nov. 14, 2014, entitled CELEBRITY INTERACTION SYSTEM, the disclosure of which is incorporated by reference herein in its entirety.

### BACKGROUND

Many people enjoy the opportunity to interact with a well-known person. For example, sports fans may wait for hours before or after a sporting event for the opportunity to get a glimpse of or talk with a favorite athlete. Sometimes well-known people participate in public events, such as to give out autographs or pose with fans for pictures, but such events pose security concerns and often require the celebrity to spend extra time travelling to and from the event. For these and other reasons, the opportunity for a fan to personally interact with a celebrity is typically quite limited.

### SUMMARY

In general terms, this disclosure is directed to personal communications. In one possible configuration and by non-limiting example, the disclosure relates to a celebrity interaction system that facilitates personal face to face communication between a fan and a celebrity across a network. Various aspects are described in this disclosure, which include, but are not limited to, the following aspects.

One aspect is a celebrity interaction system comprising: one or more computing devices including one or more processing devices and one or more computer readable storage media, the one or more computer readable storage media storing data instructions, which when executed by the one or more processing devices, cause the one or more processing devices to: generate a celebrity profile including information about a celebrity; define a celebrity schedule based on input from one of a celebrity and a celebrity's agent, the schedule identifying days and times at which the celebrity will be available for a personal communication with a fan; provide the celebrity profile and the schedule to a fan; receive input from the fan identifying a time in the celebrity schedule; schedule the personal communication between the fan and the celebrity at the identified time; and facilitate the personal communication between the fan and the celebrity at the identified time.

Another aspect is a method of facilitating a personal face to face communication between a fan and a celebrity, the method comprising: generating a celebrity profile including information about a celebrity; defining a celebrity schedule based on input from one of a celebrity and a celebrity's agent, the schedule identifying days and times at which the celebrity will be available for a personal communication with a fan; providing the celebrity profile and the schedule to a fan; receiving input from the fan identifying a time in the celebrity schedule; scheduling the personal communication between the fan and the celebrity at the identified time; and facilitating the personal communication between the fan and the celebrity at the identified time.

### BRIEF DESCRIPTION OF THE DRAWINGS

FIG. 1 is a schematic block diagram illustrating an example of a system for facilitating interaction between a fan and a celebrity, including a celebrity interaction system.

FIG. 2 illustrates an exemplary architecture of a computing device that can be used to implement aspects of the present disclosure.

FIG. 3 is a schematic block diagram illustrating an example of a celebrity interaction engine of the celebrity interaction system shown in FIG. 1, including an agent interface engine, a fan interface engine, a personal communication engine, and a feedback engine.

FIG. 4 is a block diagram illustrating an example home page of the celebrity interaction system shown in FIG. 1.

FIG. 5 is a schematic block diagram illustrating an example registration page of the agent interface engine shown in FIG. 3.

FIG. 6 is a schematic block diagram illustrating an example scheduling page of the agent interface engine shown in FIG. 3.

FIG. 7 is a schematic block diagram illustrating an example of a celebrity browsing page of the fan interface engine shown in FIG. 3.

FIG. 8 is a schematic block diagram illustrating an example of a celebrity profile page of the fan interface engine shown in FIG. 3.

FIG. 9 is a schematic block diagram illustrating an example of a confirmation page of the fan interface engine shown in FIG. 3.

FIG. 10 is a schematic block diagram illustrating an example of a celebrity interface generated by the personal communication engine shown in FIG. 3.

FIG. 11 is a schematic block diagram illustrating an example of a fan interface generated by the personal communication engine shown in FIG. 3.

FIG. 12 is a schematic block diagram illustrating an example feedback page of the feedback engine shown in FIG. 3.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

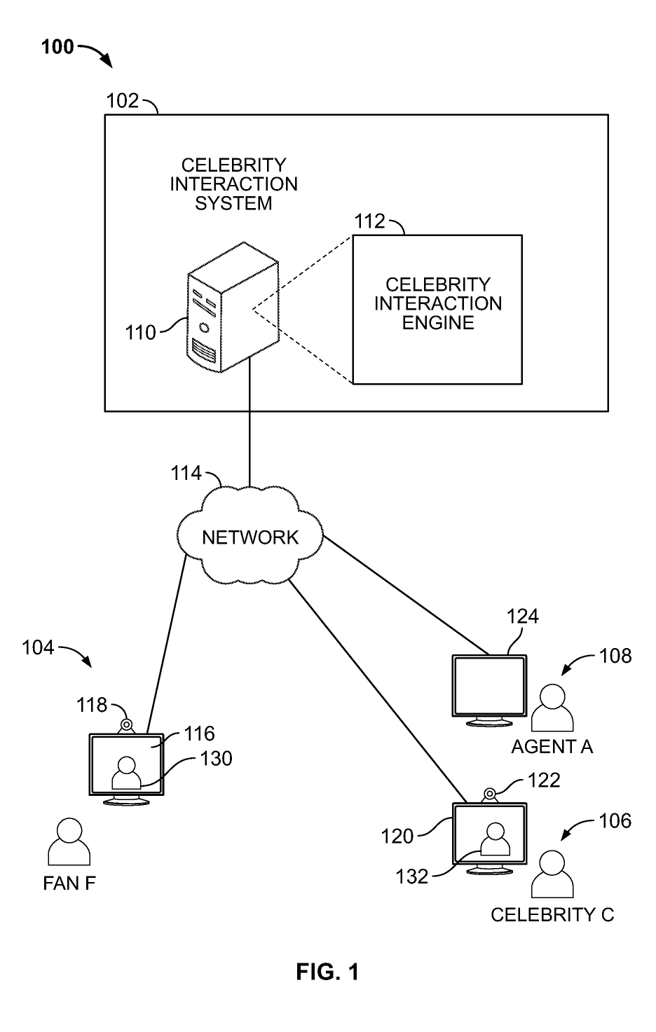

FIG. 1 is a schematic block diagram illustrating an example of a system 100 for facilitating interaction between a fan F and a celebrity C.

In this example, the system 100 includes a celebrity interaction system 102, a fan system 104, and a celebrity system 106. Some embodiments also include an agent system 108 of an agent A of the celebrity C. The example celebrity interaction system 102 includes a computing device 110 and a celebrity interaction engine 112. The example fan system 104 includes a computing device 116 and a video camera 118. The example celebrity system 106 includes a computing device 120 and a video camera 122. The example agent system 108 includes a computing device 124. In this example the computing device 116 presents a live video stream 130 of the celebrity C, and the computing device 120 presents a live video stream 132 of the fan F.

In some embodiments, the system 100 facilitates a face to face interaction between the fan F and a celebrity C (across the network 114), to allow the fan F and the celebrity C to have a personal conversation with each other. In this example the interaction involves a video conference including live video streams with audio communication. The fan and the celebrity may have a variety of different purposes for the interaction, which may include an educational purpose, a social purpose, a celebratory purpose, or other purposes. For example, a young sports player may want to have an educational discussion with a skilled professional in order for the young sports player to gain tips and insights from the professional to help the young player improve his or her own game. A fan may have a purely social purpose of talking with a celebrity C that he or she greatly admires. There can also be a celebratory purpose, in which the celebrity C is hired to congratulate the fan F on a birthday or other special occasion. The interaction can also be as part of a larger event, such as an annual company meeting in which the celebrity is hired to recognize the hard work of a company's employees or to give an encouraging or inspiring message.

The fan F is typically a person or group of people that admire, respect, or otherwise have an interest in the chosen celebrity C, and therefore wish to interact with that celebrity C through the celebrity interaction system 102.

The celebrity C is typically a well-known individual, or a relatively small group of people. Examples of celebrities include sports players (professional, semi-professional, college, high school, etc.), coaches, politicians, and entertainers (such as movie stars or other actors; radio, television, or online personalities; musicians), business leaders, and the like.

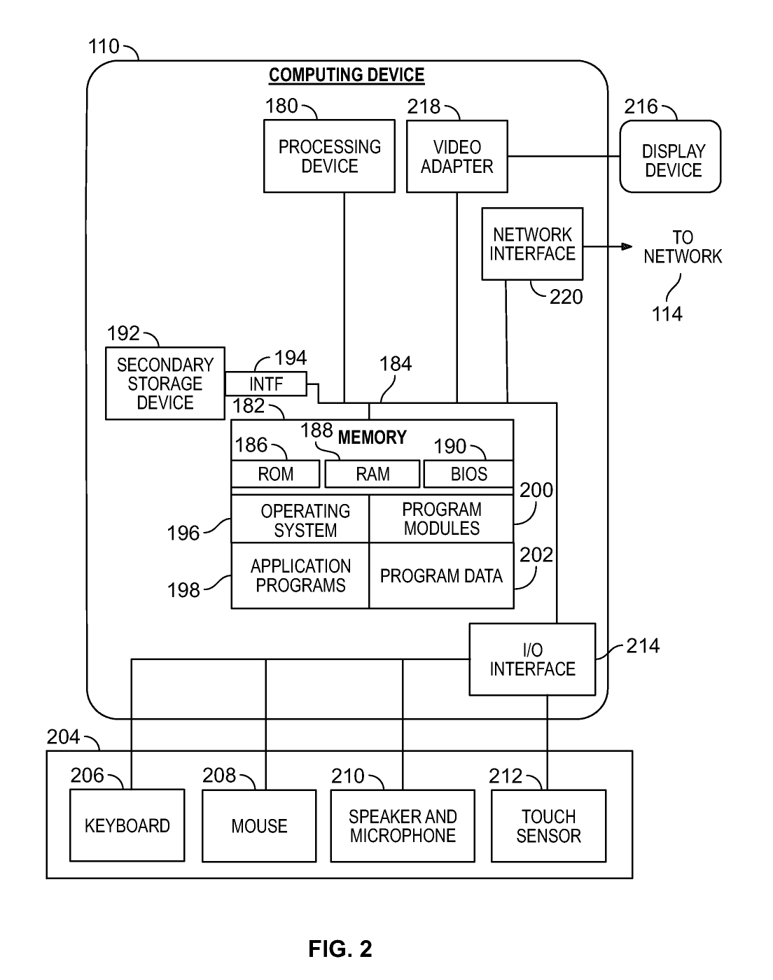

The celebrity interaction system 102 includes one or more computing devices 110. An example of the computing device 110 is illustrated and described in further detail with reference to FIG. 2. In some embodiments the computing device 110 is or includes a web server computing device.

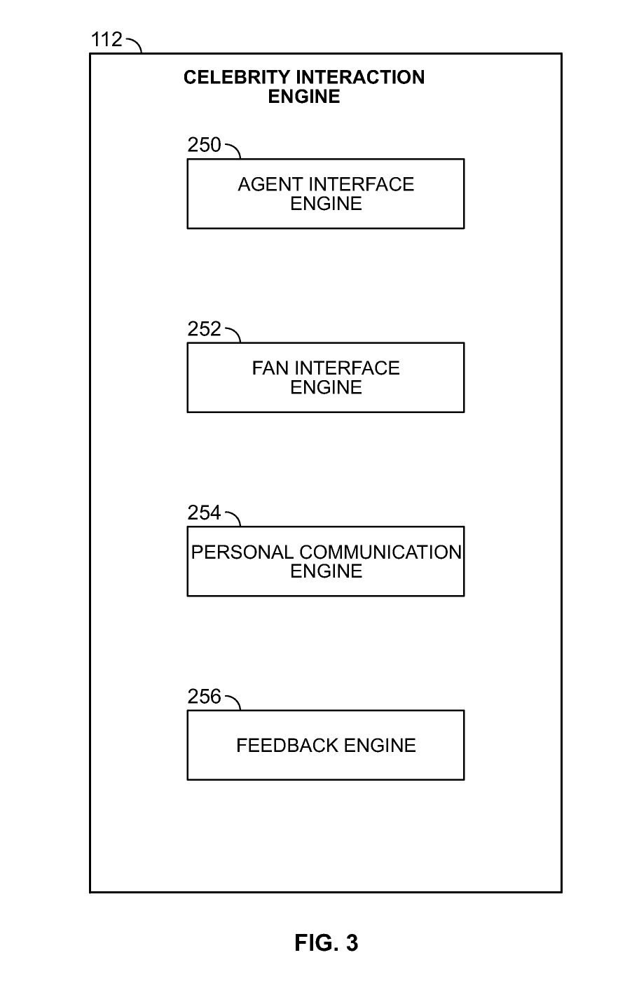

The celebrity interaction system 102 also includes a celebrity interaction engine 112. An example of the celebrity interaction engine 112 is illustrated and described in further detail with reference to FIGS. 3-12. In the illustrated example the celebrity interaction engine 112 is shown as operating on the computing device 110, but other embodiments can have other configurations. For example, part or all of the celebrity interaction engine can also be implemented on one or more of the computing devices 116, 120, and 124, or other computing devices.

Each of the participants, including the fan F, celebrity C, and agent A, typically interact with the celebrity interaction system 102 through one or more computing devices 116, 120, and 124, which can include a desktop computer, tablet computer, smart phone, laptop computer, and the like.

Additionally, any of the participants that participate in a personal conversation including a live video stream also utilize one or more video cameras 118 and 122 to capture and generate a live video stream that is sent to the other participant. An audio conversation includes at least a microphone and a speaker, which may be parts of the video camera or separate devices. Additionally, in some embodiments the video camera, microphone, and/or the speaker are components of one or more of the computing devices 116, 120, and 124.

As discussed in further detail herein, the celebrity interaction system 102 operates in at least some embodiments to setup and facilitate a personal face to face conversation between the fan F and the celebrity C. During the conversation, the video camera 118 of the fan system 104 generates a live video stream 132 that is transmitted through the network 114 to the celebrity system 106 and presented to the celebrity C by the computing device 120. Similarly, the video camera 122 of the celebrity system 106 generates a live video stream 130 that is transmitted through the network 114 to the fan system 104 and presented to the fan F by the computing device 120.

The network 114 includes one or more data communication networks. Such networks can include wired, wireless, and fiber optic networks, for example. Examples of networks include one or more of the Internet, a local area network, a cable television network, and a cellular communication network, and combinations thereof.

FIG. 2 illustrates an exemplary architecture of a computing device that can be used to implement aspects of the present disclosure, including any of the plurality of computing devices 110, 116, 120, or 124. The computing device illustrated in FIG. 2 can be used to execute the operating system, application programs, and software modules (including the software engines) described herein. By way of example, the computing device will be described below as an example of the computing device 110 of the celebrity interaction system 102. To avoid undue repetition, this description of the computing device will not be separately repeated herein for each of the other computing devices, including the fan computing device 116, the celebrity computing device 120, and the agent computing device 124, but such devices can also be configured as illustrated and described with reference to FIG. 2.

The computing device 110 includes, in some embodiments, at least one processing device 180, such as a central processing unit (CPU). A variety of processing devices are available from a variety of manufacturers, for example, Intel or Advanced Micro Devices. In this example, the computing device 110 also includes a system memory 182, and a system bus 184 that couples various system components including the system memory 182 to the processing device 180. The system bus 184 is one of any number of types of bus structures including a memory bus, or memory controller; a peripheral bus; and a local bus using any of a variety of bus architectures.

Examples of computing devices suitable for the computing device 110 include a server computer, a desktop computer, a laptop computer, a tablet computer, a mobile computing device (such as a smart phone, an iPod® or iPad® mobile digital device, or other mobile devices), or other devices configured to process digital instructions.

The system memory 182 includes read only memory 186 and random access memory 188. A basic input/output system 190 containing the basic routines that act to transfer information within computing device 110, such as during start up, is typically stored in the read only memory 186.

The computing device 110 also includes a secondary storage device 192 in some embodiments, such as a hard disk drive or a solid state drive, for storing digital data. The secondary storage device 192 is connected to the system bus 184 by a secondary storage interface 194. The secondary storage devices 192 and their associated computer readable media provide nonvolatile storage of computer readable instructions (including application programs and program modules), data structures, and other data for the computing device 110.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 192 or memory 182, including an operating system 196, one or more application programs 198, other program modules 200 (such as the software engines described herein), and program data 202. The computing device 110 can utilize any suitable operating system, such as Microsoft Windows™, Google Chrome™, Apple OS, and any other operating system suitable for a computing device.

In some embodiments, a user provides inputs to the computing device 110 through one or more input devices 204. Examples of input devices 204 include a keyboard 206, mouse 208, speaker and microphone 210, and touch sensor 212 (such as a touchpad or touch sensitive display). Other embodiments include other input devices 204. The input devices are often connected to the processing device 180 through an input/output interface 214 that is coupled to the system bus 184. These input devices 204 can be connected by any number of input/output interfaces, such as a parallel port, serial port, game port, or a universal serial bus. Wireless communication between input devices and the interface 214 is possible as well, and includes infrared, BLUETOOTH® wireless technology, 802.11a/b/g/n, cellular, or other radio frequency communication systems in some possible embodiments.

In this example embodiment, a display device 216, such as a monitor, liquid crystal display device, projector, or touch sensitive display device, is also connected to the system bus 184 via an interface, such as a video adapter 218. In addition to the display device 216, the computing device 110 can include various other peripheral devices (not shown), such as speakers or a printer.

When used in a local area networking environment or a wide area networking environment (such as the Internet), the computing device 110 is typically connected to the network 114 through a network interface 220, such as an Ethernet interface. Other possible embodiments use other communication devices. For example, some embodiments of the computing device 110 include a modem for communicating across the network.

The computing device 110 typically includes at least some form of computer readable media. Computer readable media includes any available media that can be accessed by the computing device 110. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 110. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 2 is also an example of programmable electronics, which may include one or more such computing devices, and when multiple computing devices are included, such computing devices can be coupled together with a suitable data communication network so as to collectively perform the various functions, methods, or operations disclosed herein.

FIG. 3 is a schematic block diagram illustrating an example of the celebrity interaction engine 112 of the celebrity interaction system 102, shown in FIG. 1. In this example, the celebrity interaction engine 112 includes an agent interface engine 250, a fan interface engine 252, a personal communication engine 254, and a feedback engine.

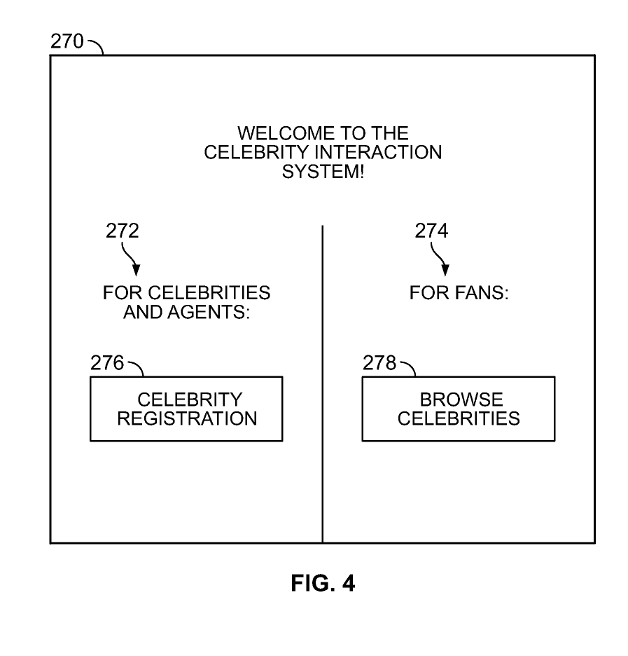

The agent interface engine 250 operates to interface with the agent A representing the celebrity C, such as to register the celebrity to participate in the celebrity interaction system 102 and to define a schedule of dates and times at which the celebrity is available for a personal communication with a fan. An example of the agent interface engine 250 is illustrated and described in further detail with reference to FIGS. 4-6. The agent interface engine 250 can also or alternatively be used to interface directly with the celebrity C.

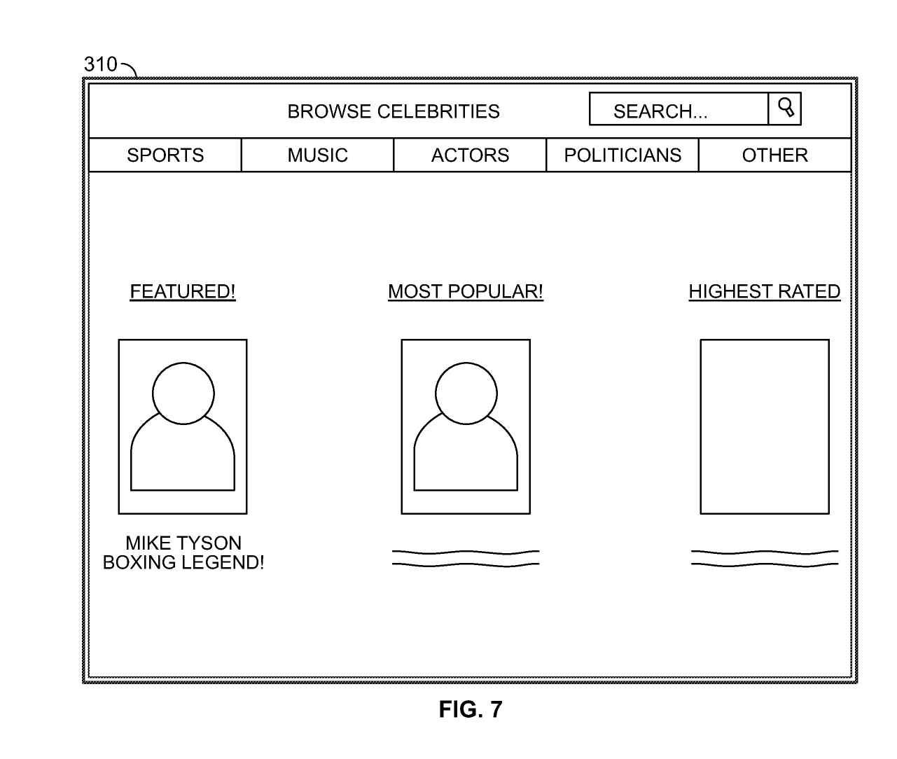

The fan interface engine 252 operates to interface with the fan, or another person on behalf of the fan, such as to allow the fan to browse listings and schedules of celebrities who are available for personal communication, and to schedule a personal communication with a celebrity. An example of the fan interface engine 252 is illustrated and described in further detail with reference to FIGS. 7-9.

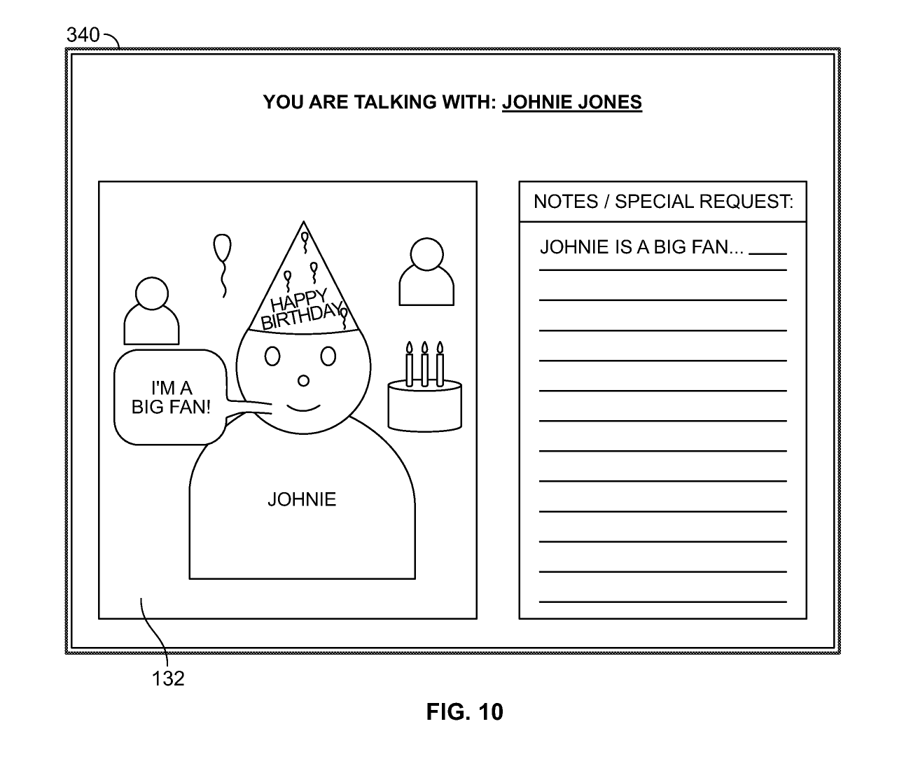

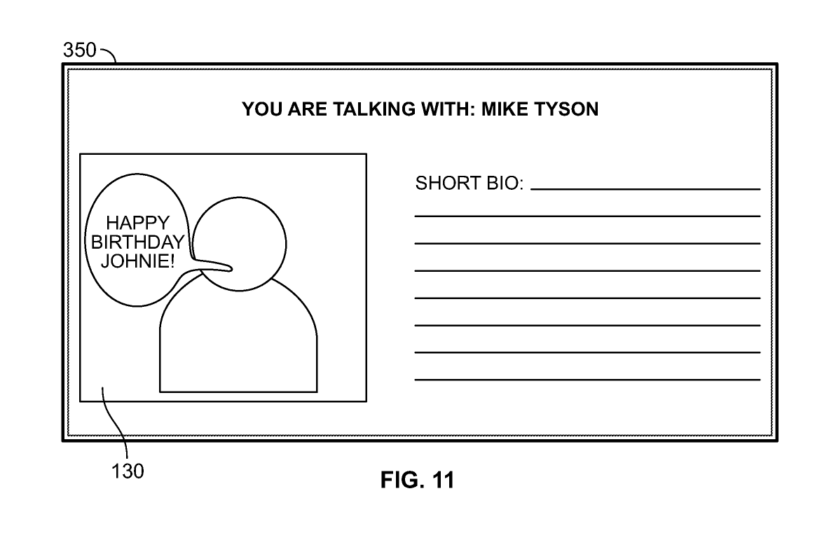

The personal communication engine 254 operates to facilitate a personal communication between the fan F and the celebrity C. An example of the personal communication engine 254 is illustrated and described in further detail with reference to FIGS. 10-11.

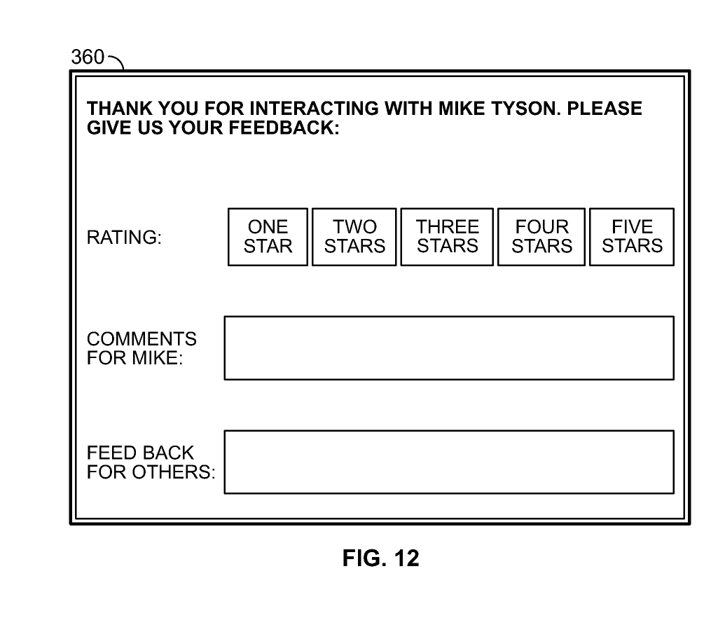

The feedback engine 256 operates to collect feedback from the fan F regarding the personal communication after it has concluded. An example of the feedback engine 256 is illustrated and described in further detail with reference to FIG. 12.

FIG. 4 is a block diagram illustrating an example home page 270 of the celebrity interaction system 102, such as displayed on one of the fan system 104, celebrity system 106, or agent system 108 (shown in FIG. 1). In this example, the home page includes a celebrities and agents welcome section 272 and a fans welcome section 274. The celebrities and agents welcome section 272 includes a celebrity registration button 276. The fans welcome section 274 includes a browse celebrities button 278.

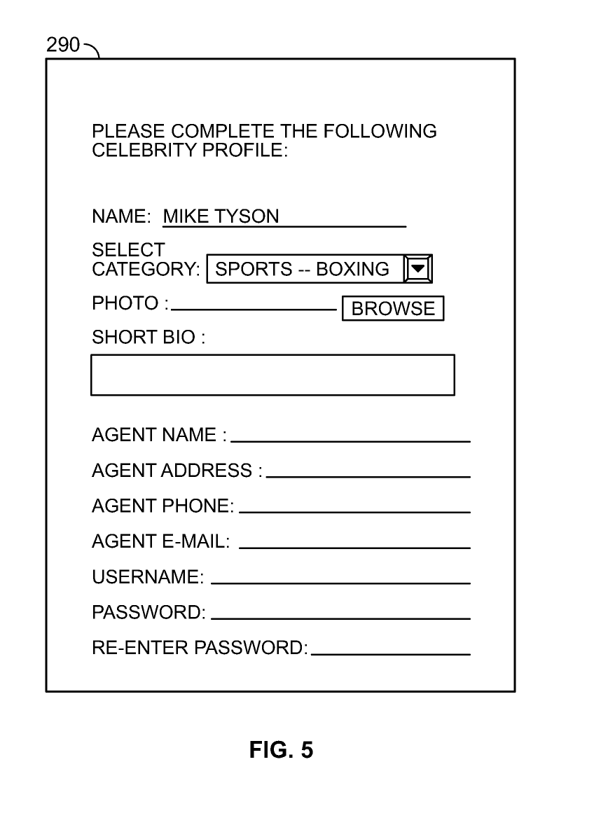

In this example, the home page 270 includes a welcome message, and also includes at least two welcome sections 272 and 274. The section 272 operates to welcome celebrities and agents, and prompts the celebrity or agent to select the celebrity registration button 276. The celebrity interaction system 102 then initiates the agent interface engine 250 (FIG. 3), as illustrated in FIG. 5. The section 274 operates to welcome fans, and prompts the fan to select the browse celebrities button 278. The celebrity interaction engine 112 then initiates the fan interface engine 252, as illustrated in FIG. 7.

The home page 270 can take a variety of different forms in other possible embodiments. Additionally, in some embodiments separate home pages are provided for celebrities or agents, and fans, to take the participants directly to the user interfaces associated with the agent interface engine 250 or the fan interface engine 252, respectively.

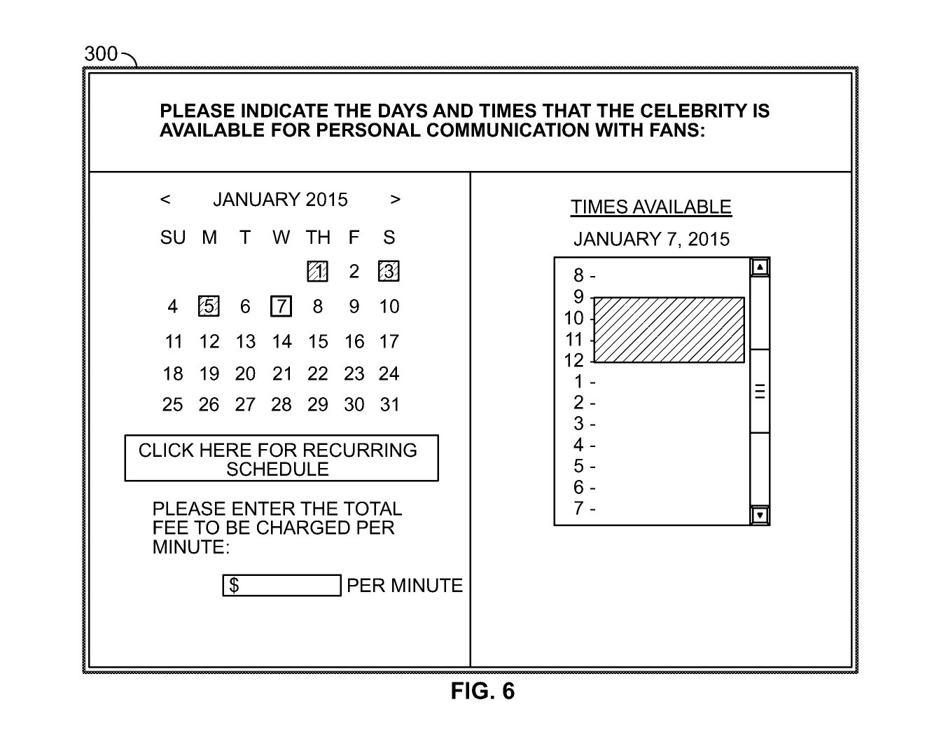

FIGS. 5-6 illustrate an example of the agent interface engine 250, shown in FIG. 3.

FIG. 5 is a schematic block diagram illustrating an example registration page 290 of the agent interface engine 250.

In some embodiments, the agent interface engine 250 prompts the agent A (or the celebrity C) to complete a celebrity profile in order to register the celebrity with the celebrity interaction system 102. In this example, the celebrity profile includes the celebrities name, a celebrity category, a photograph, a short bio, and agent information. In addition, at least one username and password are defined to allow the agent A and/or the celebrity to subsequently login to the celebrity interaction system.

At least some of the celebrity profile is then subsequently used by the celebrity interaction system 102 to include the celebrity in celebrity listings and search results.

The agent information can be used for verification purposes, and may also be used for sending future payments to the agent for the celebrity's participation in personal communication sessions with fans, for example.

FIG. 6 is a schematic block diagram illustrating an example scheduling page 300 of the agent interface engine 250.

The scheduling page 300 prompts the agent A or the celebrity to specify a schedule of dates and times at which the celebrity will be available for personal communication with fans. In this example the agent selects a date from the calendar, and then selects one or more time blocks in which the celebrity will be available on that date. In some embodiments a recurring schedule can be defined.

In some embodiments the agent interface engine 250 also prompts the agent to indicate a fee that should be charged for personal interaction with the celebrity. In some embodiments the fee is the total fee charged to a fan per unit of time (e.g., per minute).

In some embodiments the celebrity interaction engine receives and processes fee payments (such as through a third party payment service) from fans. In some embodiments the celebrity interaction system keeps a portion of the fees received, such as a flat fee or a percentage, and pays the remaining portion of the fees received to the agent or to the celebrity. In some embodiments payments are made to a charity selected by the agent or the celebrity. The payments may be made electronically or via mail, for example. In another possible embodiment, fees paid by fans are paid directly to the agent or to the celebrity, and the agent or the celebrity pay a separate fee to the celebrity interaction system 102. In another possible embodiment, the celebrity interaction system can be funded from other sources, such as advertising.

FIGS. 7-9 illustrate an example of the fan interface engine 252, shown in FIG. 3.

FIG. 7 is a schematic block diagram illustrating an example of a celebrity browsing page 310 of the fan interface engine 252.

In this example, a fan has been directed to a fan interface engine 252 and is presented with listings of celebrities C who are available for personal communication with the fan through the celebrity interaction system 102.

Various listings of celebrity profiles can be provided, such as listings of featured celebrities, the celebrities most popular in the celebrity interaction system, the celebrities that are most highly rated in the celebrity interaction system, the celebrities that charge the lowest or highest fee per unit of time, or a variety of other possible listings. Additionally, celebrity profiles can also be sorted by category, such as by whether the celebrity is known for sports, music, acting, politics, or other categories.

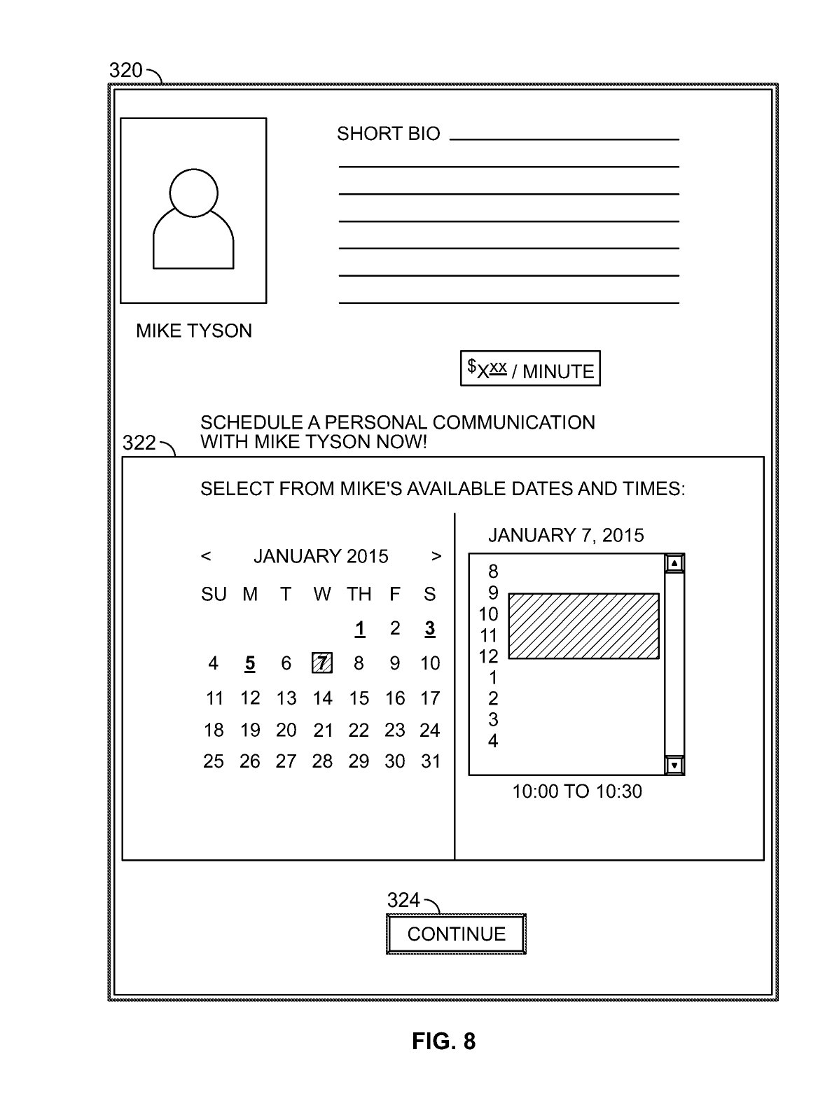

Once a celebrity has been identified that the fan is interested in, the fan can select on the celebrity profile to view a more detailed profile. An example of a celebrity profile is shown in FIG. 8.

FIG. 8 is a schematic block diagram illustrating an example of a celebrity profile page 320. In this example, more detailed information about the celebrity is displayed, including the celebrities name, a photograph, and a short bio, for example. Additionally, the celebrity's fee per unit of time is displayed, along with the celebrity's schedule 322.

If the fan wants to schedule a personal communication with the celebrity, the fan selects a date and time from the days and times that the celebrity is available, and selects the continue button 324, for example.

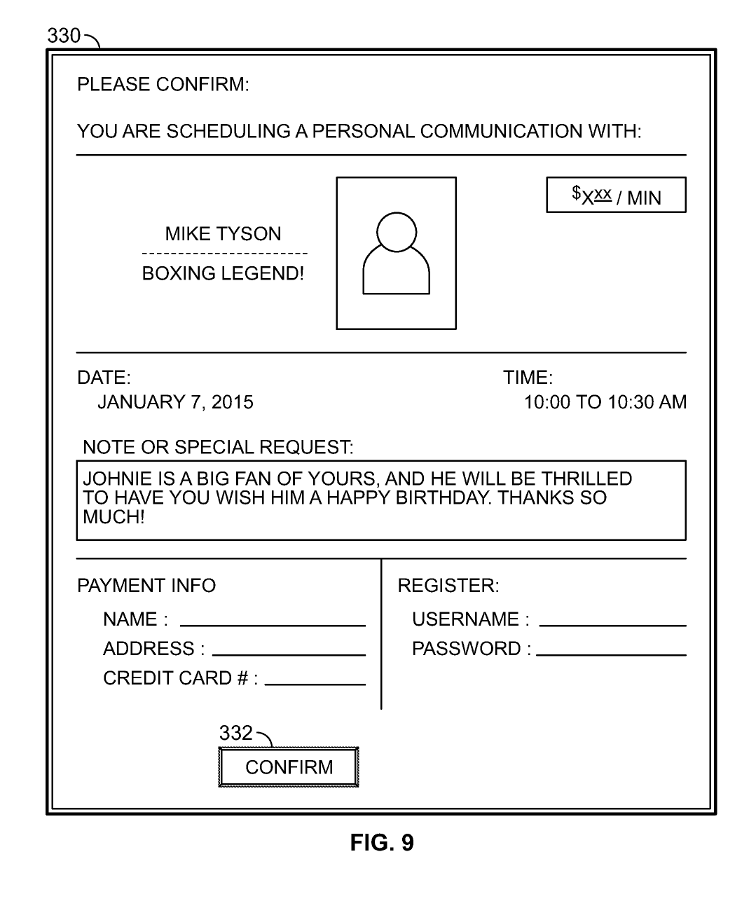

FIG. 9 is a schematic block diagram illustrating an example of a confirmation page 330. In this example, the confirmation page 330 displays the details of the proposed personal communication with the celebrity.

In some embodiments the fan (or a representative of the fan, such as a parent, friend, colleague, or other person) confirms the information, and if desired, enters a note or special request to be provided to the celebrity before or during the session.

Payment information is collected, and a fan account is generated, such as including a username and a password that can be used to login for the personal communication at the scheduled time. In another possible embodiment an access code or link is sent to the fan or fan's representative that can be used to access the personal communication at the scheduled time.

Once all of the appropriate information has been entered and confirmed, the confirm button 332 is selected to complete the scheduling of the personal communication.

FIGS. 10-11 illustrate an example of the personal communication engine 254, shown in FIG. 3.

FIG. 10 is a schematic block diagram illustrating an example of a celebrity interface 340 generated by the personal communication engine 254 (FIG. 3). In this example, the celebrity interface 340 is a user interface that is displayed to the celebrity at the time of the personal communication.

In this example, the celebrity interface displays the name of the fan, the video stream 132 of the fan, and any notes or special requests that were provided. The celebrity interacts with the fan during the personal communication session until the session has concluded.

FIG. 11 is a schematic block diagram illustrating an example of a fan interface 350 generated by the personal communication engine 254 (FIG. 3). In this example, the fan interface 350 is a user interface that is displayed to the fan at the time of the personal communication.

In this example, the fan interface displays the name of the celebrity, the video stream 130 of the celebrity, and other possible information, such as a short bio of the celebrity. The fan interacts with the celebrity during the personal communication session until the session has concluded.

In some embodiments, the video feeds 130 and 132 described herein utilize a video telephony software, such as the Skype® software or the FaceTime® software.

FIG. 12 illustrates an example of the feedback engine 256 of the celebrity interaction engine 112, shown in FIG. 3.

FIG. 12 is a schematic block diagram illustrating an example feedback page 360 generated by the feedback engine 256.

In some embodiments the feedback page 360 is displayed to the fan after the personal communication session with the celebrity has concluded. In this example, the feedback page 360 is displayed that prompts the fan for feedback regarding the personal communication session. For example, the fan is prompted to rate the personal communication on a scale from one star to five stars. Other ratings can also be requested, such as to prompt the fan to rank the personal communication based on one or more criteria (entertainment rating, educational rating, courtesy rating, value rating, etc). Such ratings can be subsequently be compiled and displayed in the celebrities profile, and can be used for sorting and ranking of celebrities.

In some embodiments the fan is prompted to enter comments, such as comments to be provided to the celebrity (e.g., a personalized thank you note), and comments to be provided to others (e.g., a review of the personal communication session).

The system 100 disclosed herein can also function to facilitate personal communications between other parties, in addition to or instead of a fan and a celebrity. As one example, the system can facilitate communication between a sports player and an agent. As another example, the system can facilitate communication between a skilled person and a less skilled person, for the purpose of training or mentoring the less skilled person.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A celebrity interaction system comprising: one or more computing devices including one or more processing devices and one or more computer readable storage media, the one or more computer readable storage media storing data instructions, which when executed by the one or more processing devices, cause the one or more processing devices to:
generate a celebrity profile including information about a celebrity;
define a celebrity schedule based on input from one of a celebrity and a celebrity's agent, the schedule identifying days and times at which the celebrity will be available for a personal communication with a fan;
provide the celebrity profile and the schedule to a fan;
receive input from the fan identifying a time in the celebrity schedule;
schedule the personal communication between the fan and the celebrity at the identified time; and
facilitate the personal communication between the fan and the celebrity at the identified time.

2. A method of facilitating a personal face to face communication between a fan and a celebrity, the method comprising:
generating a celebrity profile including information about a celebrity;
defining a celebrity schedule based on input from one of a celebrity and a celebrity's agent, the schedule identifying days and times at which the celebrity will be available for a personal communication with a fan;
providing the celebrity profile and the schedule to a fan;
receiving input from the fan identifying a time in the celebrity schedule;
scheduling the personal communication between the fan and the celebrity at the identified time; and
facilitating the personal communication between the fan and the celebrity at the identified time.
